(19) United States
(12) Patent Application Publication
(10) Pub. No.: US 2025/0248869 A1
(43) Pub. Date: Aug. 7, 2025

(54) WHEELCHAIR GUARDIAN OPERATING HANDLE CONTROL SYSTEM AND METHOD

(71) Applicant: FOUNDATION OF SOONGSIL UNIVERSITY-INDUSTRY COOPERATION, Seoul (KR)

(72) Inventors: Jang Woo SHON, Paju-si (KR); Sang Lak LEE, Seoul (KR)

(21) Appl. No.: 19/044,780

(22) Filed: Feb. 4, 2025

(30) Foreign Application Priority Data
Feb. 5, 2024 (KR) 10-2024-0017551

(51) Int. Cl. A61G 5/04

(52) U.S. Cl. CPC A61G 5/048

(57) ABSTRACT

A wheelchair guardian operating handle control system and method are provided. A wheelchair guardian operating handle control system configured to operate a wheelchair capable of moving by receiving power using an electric drive system, according to an embodiment, includes: a pressure acquisition unit that is mounted on the rear of the wheelchair and acquires a control pressure, which is a pressure applied by a guardian; a control information generation unit that processes the control pressure to determine a moving speed and generates control information for controlling wheels provided on the wheelchair according to the moving speed; and a wheel driving unit that acquires the control information and respectively controls the speeds of the wheels provided on opposite sides of the wheelchair according to the control information to perform movement of the wheelchair.

### CROSS REFERENCE TO RELATED APPLICATIONS

This application claims priority from Korean Patent Application No. 10-2024-0017551, filed on Feb. 5, 2024, in the Korean Intellectual Property Office, which is incorporated herein by reference in its entirety.

### BACKGROUND

The disclosure relates to a wheelchair guardian operating handle control system and method, and more particularly, to a wheelchair guardian operating handle control system and method that enable a wheelchair guardian to control the speed and direction of a wheelchair by using a handle configured at the rear of the wheelchair.

Most existing wheelchairs are designed so that a rider directly controls the direction by turning wheels to provide power or by holding a handle at the back of the wheelchair to provide power and control the direction. These wheelchairs have low mobility efficiency because they use human power, and there is a problem that they cannot sufficiently guarantee the right to mobility for wheelchair users because they are difficult to move for a long time.

To solve the above problems, electric wheelchairs or manual wheelchairs with a power structure have been developed that can move the wheelchair using electric power by including a power structure in a general manual wheelchair.

In the case of electric wheelchairs, most are configured in a form where the rider controls the left, right, forward, and backward movements from the front using a joystick. Therefore, a guardian's control of an electric wheelchair is impossible. As the use of electric wheelchairs increases in hospitals, airports, parks, etc., a driving method that allows a guardian, transporter, nurse, etc. to drive from the back of an electric wheelchair when a rider cannot drive is required.

However, since a joystick is located at the front, it is difficult to control if the rider is not the one using the joystick, and in the case of electric wheelchairs, the weight is much heavier than that of conventional wheelchairs due to essential components, so it is very difficult for a guardian to push the electric wheelchair from behind to move the electric wheelchair.

### RELATED ART DOCUMENT

### [Patent Document]

Korean Patent Registration No. 10-2543160

### SUMMARY

An aspect of the disclosure is to provide a wheelchair guardian operating handle control system and method that can enable a guardian to easily control the wheelchair from behind by providing a handle control device controllable by a guardian at the rear of a wheelchair that operates using an electric device.

The aspect of the disclosure is not limited to the aspect mentioned above, and other aspects not mentioned may be clearly understood by a person having ordinary skill in the technical field to which the disclosure belongs from the description below.

According to an aspect of the disclosure, a wheelchair guardian operating handle control system is provided. The wheelchair guardian operating handle control system configured to operate a wheelchair capable of moving by receiving power using an electric drive system includes: a pressure acquisition unit that is mounted on the rear of the wheelchair and acquires a control pressure, which is a pressure applied by a guardian; a control information generation unit that processes the control pressure to determine a moving speed and generates control information for controlling wheels provided on the wheelchair according to the moving speed; and a wheel driving unit that acquires the control information and respectively controls the speeds of the wheels provided on opposite sides of the wheelchair according to the control information to perform movement of the wheelchair.

The pressure acquisition unit may include: a left pressure acquisition module, which is mounted on the left rear side based on the direction of movement of the wheelchair and obtains a left control pressure applied by the guardian; and a right pressure acquisition module, which is mounted on the right rear side based on the direction of movement of the wheelchair and obtains a right control pressure applied by the guardian.

The control information generation unit may include: a state estimation module that obtains the control pressure, estimates an optimal control and Kalman filter state, and generates state estimation information; a speed information generation module that generates speed information corresponding to the control pressure according to a preset criterion; and a control information derivation module that reflects the state estimation information in the speed information and derives the control information.

The wheel driving unit may include: a left power providing module that provides left power, which is power for a left wheel installed on the wheelchair, in an amount included in left control information if the control information includes the left control information; and a right power providing module that provides right power, which is power for a right wheel installed on the wheelchair, in an amount included in the left control information if the control information includes right control information.

According to an aspect of the disclosure, a method for controlling a guardian operating handle for a wheelchair is provided. The method for controlling a guardian operating handle for a wheelchair configured to operate a wheelchair capable of moving by receiving power using an electric drive scheme includes: a pressure acquisition step of acquiring a control pressure, which is a pressure applied by a guardian, using a pressure acquisition unit mounted on the rear of the wheelchair; a control information generation step of processing the control pressure using a control information generation unit to determine a moving speed, and generating control information for controlling wheels provided on the wheelchair according to the moving speed; and a wheel driving step of acquiring the control information using a wheel driving unit, and respectively controlling the speeds of the wheels provided on opposite sides of the wheelchair according to the control information to perform movement of the wheelchair.

The pressure acquisition step may include: a left pressure acquisition step of performing mounting on the left rear side based on the direction of movement of the wheelchair and acquiring a left control pressure applied by the guardian; and a right pressure acquisition step of performing mounting on the right rear side based on the direction of movement of the wheelchair and acquiring a right control pressure applied by the guardian.

The control information generation step may include: a state estimation step of obtaining the control pressure and estimating an optimal control and Kalman filter state to generate state estimation information; a speed information generation step of generating speed information corresponding to the control pressure according to a preset criterion; and a control information derivation step of deriving the control information by reflecting the state estimation information into the speed information.

The wheel driving step may include: a left power providing step of providing left power, which is power for a left wheel installed on the wheelchair, in an amount included in left control information if the control information includes the left control information; and a right power providing step of providing right power, which is power for a right wheel installed on the wheelchair, in an amount included in the left control information if the control information includes right control information.

A wheelchair guardian operating handle control system and method according to an embodiment of the disclosure has the effect of enabling a guardian to easily control a wheelchair from behind by providing a handle control device controllable by the guardian at the rear of the wheelchair that operates using an electric device.

The effect of the disclosure is not limited to the effect described above, and should be understood to include all effects that are inferable from the detailed description of the disclosure or the configuration of the invention described in the claims.

### BRIEF DESCRIPTION OF THE DRAWINGS

The above and other aspects, features, and advantages of certain embodiments of the disclosure will be more apparent from the following description taken in conjunction with the accompanying drawings, in which:

FIG. 1 is a block diagram of a wheelchair guardian operating handle control system according to an embodiment of the disclosure;

FIG. 2 is a block diagram of a pressure acquisition unit of FIG. 1;

FIG. 3 is a block diagram of a control information generation unit of FIG. 1;

FIG. 4 is a block diagram of a wheel driving unit of FIG. 1;

FIG. 5 is a flow chart of a wheelchair guardian operating handle control method according to an embodiment of the disclosure;

FIG. 6 is a flow chart of step S11 of FIG. 5;

FIG. 7 is a flow chart of step S13 of FIG. 5;

FIG. 8 is a flow chart of step S15 of FIG. 5;

FIG. 9 is an example diagram of a pressure acquisition unit installed at the rear of a wheelchair according to an embodiment of the disclosure;

FIG. 10 is a diagram of an LQR optimal speed loop control circuit that may be used according to an embodiment of the disclosure; and

FIG. 11 is a diagram visualizing an example of an algorithm that may perform observation through LQR optimal control and eigenvalue allocation of the disclosure.

### DETAILED DESCRIPTION

Hereinafter, some embodiments of the disclosure will be described in detail with reference to exemplary drawings. When adding reference numerals to components of each drawing, the same components may have the same numerals as much as possible even if they are shown in different drawings. In addition, when describing the embodiments, if it is determined that a specific description of a related known configuration or function may obscure the gist of the present technical idea, the detailed description may be omitted. When “include,” “have,” “be composed of,” etc. are used in this specification, other parts may be added unless “only” is used. When a component is expressed in a singular form, it may include a case where it includes a plurality unless there is a special explicit description.

In addition, when describing the components of the disclosure, terms such as first, second, A, B, (a), (b), etc. may be used. These terms are only intended to distinguish the components from other components, and the nature, order, sequence, or number of the corresponding components are not limited by the terms.

In the description of the positional relationship of components, if it is described that two or more components are “connected”, “combined” or “linked”, it should be understood that the two or more components may be directly “connected”, “combined” or “linked”, but the two or more components may be “connected”, “combined” or “linked” with another component further “interposed”. Here, the other component may be included in one or more of the two or more components that are “connected”, “combined” or “linked” to each other.

In the description of the temporal flow relationship related to components, operation methods, or manufacturing methods, for example, when the temporal chronological relationship or the chronological chronological relationship is described as “after . . . ,” “following . . . ,” “next to . . . ,” or “before . . . ,” it may also include cases where it is not continuous unless “immediately” or “directly” is used.

Meanwhile, when a numerical value or corresponding information (e.g., level, etc.) for a component is mentioned, even if there is no separate explicit description, the numerical value or corresponding information may be interpreted as including an error range that may occur due to various factors (e.g., process factors, internal or external impact, noise, etc.).

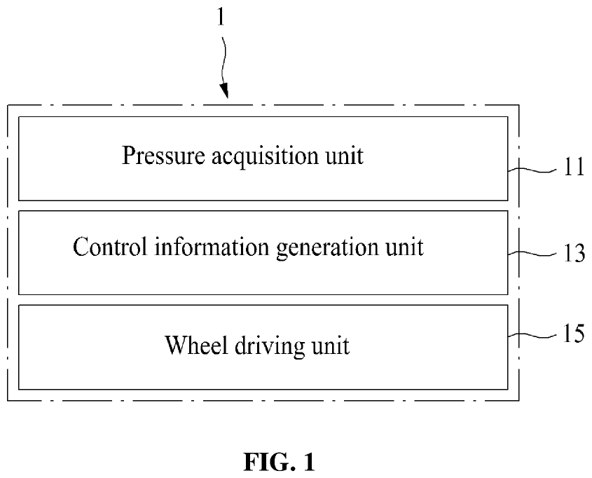

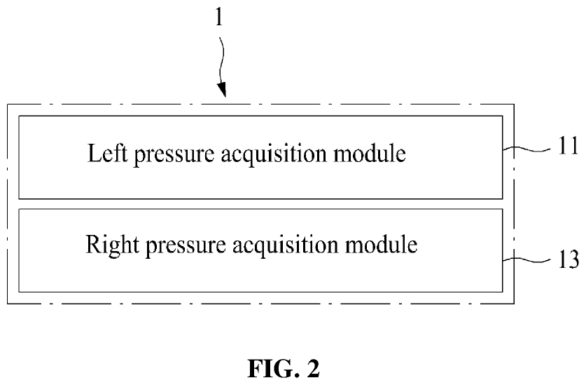

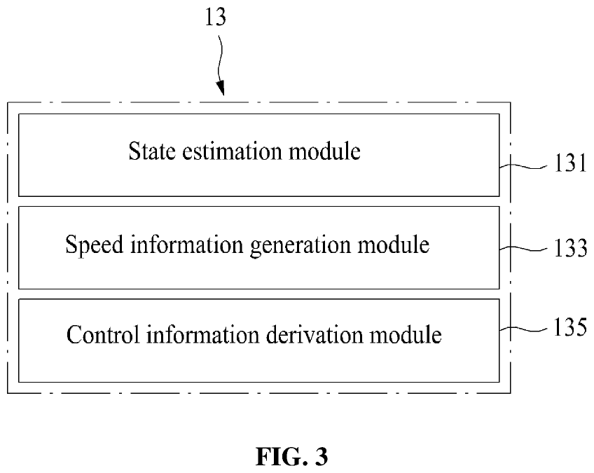

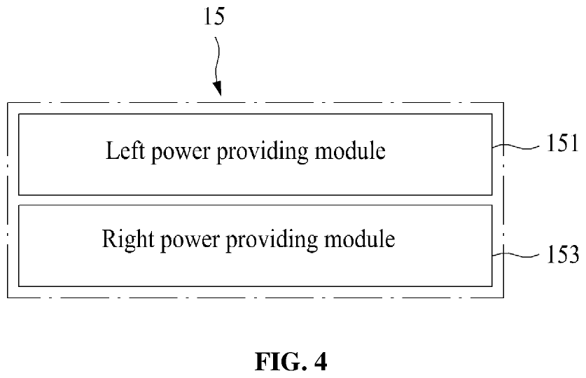

FIGS. 1 to 4 illustrate an embodiment of a wheelchair guardian operating handle control system of the disclosure. FIG. 1 is a block diagram of a wheelchair guardian operating handle control system according to an embodiment of the disclosure, FIG. 2 is a block diagram of a pressure acquisition unit of FIG. 1, FIG. 3 is a block diagram of a control information generation unit of FIG. 1, and FIG. 4 is a block diagram of a wheel driving unit of FIG. 1. Hereinafter, the wheelchair guardian operating handle control system of the disclosure will be described in detail using FIGS. 1 to 4.

The wheelchair guardian operating handle control system 1 according to an embodiment of the disclosure is configured to operate a wheelchair that may move by receiving power using an electric drive system. The wheelchair that may move by receiving power using the electric drive system described below may be a wheelchair equipped with a wheel driving device on a manual wheelchair or an electric wheelchair. For convenience of explanation, the following description assumes that a subject matter wheelchair is an electric wheelchair.

The wheelchair guardian operating handle control system 1 according to an embodiment of the disclosure is configured to perform control of a wheelchair by using a pressure applied by a guardian when the guardian applies pressure to the rear of the electric wheelchair. To this end, the wheelchair guardian operating handle control system 1 according to one embodiment of the disclosure is configured to include a pressure acquisition unit 11, a control information generation unit 13, and a wheel driving unit 15 as shown in FIG. 1.

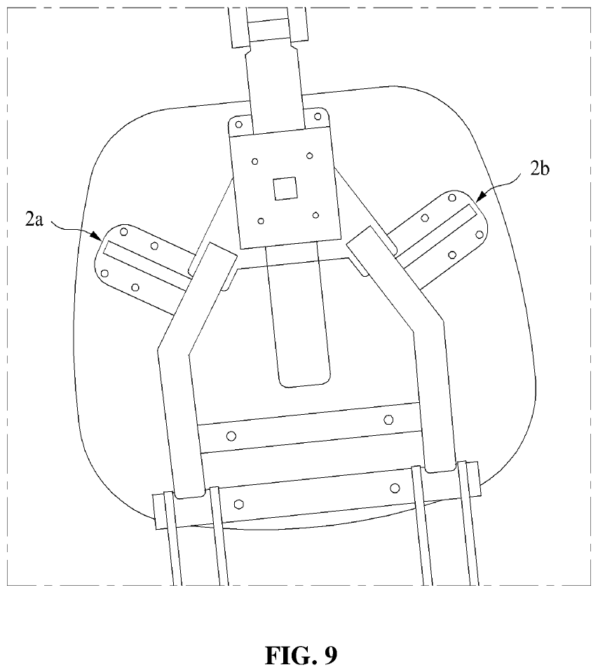

The pressure acquisition unit 11 is configured to acquire a control pressure, which is the pressure applied by the guardian, by being mounted on the rear of the wheelchair. The pressure acquisition unit 11 is configured to acquire the pressure applied by the guardian when the guardian applies pressure to the rear of the electric wheelchair in the form of a strain gauge 2 as shown in FIG. 9. To this end, the pressure acquisition unit 11 according to an embodiment of the disclosure is configured to include a left pressure acquisition module 111 and a right pressure acquisition module 113 as shown in FIG. 2.

The left pressure acquisition module 111 is configured to acquire a left control pressure applied by the guardian by being mounted on the left rear side based on the direction of movement of the wheelchair. The left pressure acquisition module 111 may be configured to acquire a pressure applied to a left strain gauge 2a configured on the left side of FIG. 9.

The right pressure acquisition module 113 is configured to acquire a right control pressure applied by the guardian by being mounted on the right rear side based on the direction of movement of the wheelchair. The right pressure acquisition module 113 may be configured to acquire a pressure applied to a right strain gauge 2b configured on the right side of FIG. 9.

At this time, the left pressure acquisition module 111 and the right pressure acquisition module 113 according to an embodiment of the disclosure may be configured to acquire not only a pressure that the guardian pushes, but also a pressure that the guardian pulls toward the rear of the wheelchair. In the case of the pulling pressure, this may be acquired to slow down the moving speed of the wheelchair.

When the pressure is acquired, the control information generation unit 13 according to an embodiment of the disclosure is configured to process the control pressure to determine the moving speed and generate control information for controlling the wheels equipped on the wheelchair according to the moving speed. To this end, the control information generation unit 13 according to an embodiment of the disclosure may be configured to include a state estimation module 131, a speed information generation module 133, and a control information derivation module 135 as shown in FIG. 3.

The state estimation module 131 is configured to acquire a control pressure and estimate an optimal control and Kalman filter state to generate state estimation information. The state estimation module 131 may acquire current movement information to estimate a current movement state of the wheelchair, and further, may estimate a state for the pressure acquired through the pressure acquisition unit 11 to generate state estimation information. Here, the state estimation information is information for reducing sensor noise, disturbance, and malfunction, and for this purpose, the state estimation module 131 according to an embodiment of the disclosure may be configured to generate state estimation information using optimal control and Kalman filter algorithms.

The speed information generation module 133 is configured to generate speed information corresponding to the control pressure according to a preset criterion. The speed information generation module 133 may be configured to match the control pressure applied by the guardian to the preset criterion and generate speed information corresponding to the matched criterion. For example, the preset criterion may be set through the current speed of the wheelchair. A wheelchair is generally a device that is not boarded to perform a speed competition, but to provide mobility rights to people with limited mobility. Therefore, the speed of such a wheelchair should preferably be set to a speed similar to a walking or alarm speed.

The speed information generation module 133 is configured to check how close the current speed is to the reference speed and increase the control pressure required to increase the speed in response to the basic purpose of the wheelchair. Therefore, the speed information generation module 133 may be configured to set a pressure range for increasing the speed according to the preset criterion and generate speed information corresponding to the control pressure according to the preset criterion using the current speed and the input control pressure.

The control information derivation module 135 is configured to derive control information by reflecting the state estimation information to the speed information. The state estimation module 131 generates state estimation information including information on the current operating state of the wheelchair and control pressure, and the speed information generation module 133 generates speed information corresponding to the control pressure. Therefore, the control information derivation module 135 of the disclosure may be configured to derive control information including the degree of driving force applied to the wheels equipped on the wheelchair using the state estimation information and the speed information. More specifically, the control information derivation module 135 of the disclosure may be configured to separately derive left control information and right control information and include them all in the control information in order to control power to each of the left and right wheels described below.

The wheel driving unit 15 obtains control information and is configured to control the speed of the wheels equipped on opposite sides of the wheelchair according to the control information to perform movement of the wheelchair. To this end, the wheel driving unit 15 according to an embodiment of the disclosure may be configured to include a left power providing module 151 and a right power providing module 153 as shown in FIG. 4.

The left power providing module 151 may be configured to provide left power, which is power for a left wheel installed on the wheelchair, in an amount included in the left control information when the control information includes the left control information.

The right power providing module 153 may be configured to provide right power, which is power for a right wheel installed on the wheelchair, in an amount included in the left control information when the control information includes the right control information.

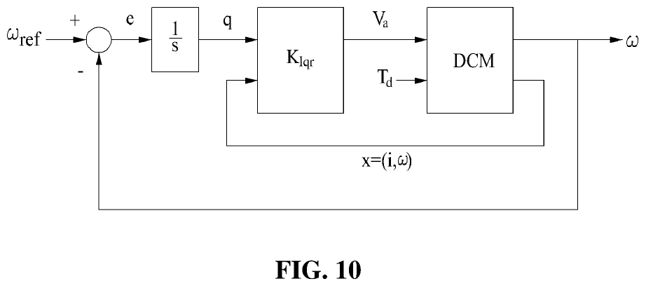

The wheelchair guardian operating handle control system 1 according to an embodiment of the disclosure described above may utilize an LQR optimal speed loop control circuit as shown in FIG. 10.

In an embodiment of the disclosure, a formula such as Equation 1 below may be used to control a two-axis control state space.

$${x}_{k + 1} = {A}_{k} {x}_{k} + {B}_{k} {u}_{k} \qquad [ Equation 1 ]$$

$${y}_{k} = {C}_{k} {x}_{k}$$

Thereafter, the state estimation module 131 of the disclosure may select an LQ optimal value by applying eigenvalue allocation and Kalman filters, and this process may be expressed by Equation 2 below.

$${\hat{x}}_{k + 1} = {A}_{k} {\hat{x}}_{k} + {B}_{k} {u}_{k} + F ( {\hat{y}}_{k} - {C}_{k} {\hat{x}}_{k} ) \qquad [ Equation 2 ]$$

$${u}_{k} = - K {\hat{x}}_{k}$$

$${x}_{k + 1} = {A}_{k} {x}_{k} - {B}_{k} K {\hat{x}}_{k}$$

$${\hat{x}}_{k + 1} = [ {A}_{k} - {FC}_{k} - {B}_{k} K ] {\hat{x}}_{k} + {FC}_{k} {x}_{k}$$

The state estimation module 131 may declare a new state as expressed in Equation 3 below.

$${X}_{k + 1} = [ \begin{matrix}{\hat{x}}_{k + 1} \\ {\hat{x}}_{k + 1}\end{matrix} ] = [ \begin{matrix}{A}_{k} & {x}_{k + 1} \\ {FC}_{k} & {A}_{k} - {FC}_{k} - {B}_{k} K\end{matrix} ] {X}_{k} \qquad [ Equation 3 ]$$

If the state estimation module 131 declares an additional new state after declaring Equation 3 above, this may be expressed as Equation 4 below.

$$\overline{{x}_{k}} = [ \begin{matrix}I & 0 \\ I & - 1\end{matrix} ] [ \begin{matrix}{x}_{k} \\ {\hat{x}}_{k}\end{matrix} ] = [ \begin{matrix}{x}_{k} \\ {x}_{k} - {\hat{x}}_{k}\end{matrix} ] = [ \begin{matrix}{x}_{k} \\ {e}_{k}\end{matrix} ] \qquad [ Equation 4 ]$$

Here, xₖ means the current state, and ek means the error between the estimated value and the current value.

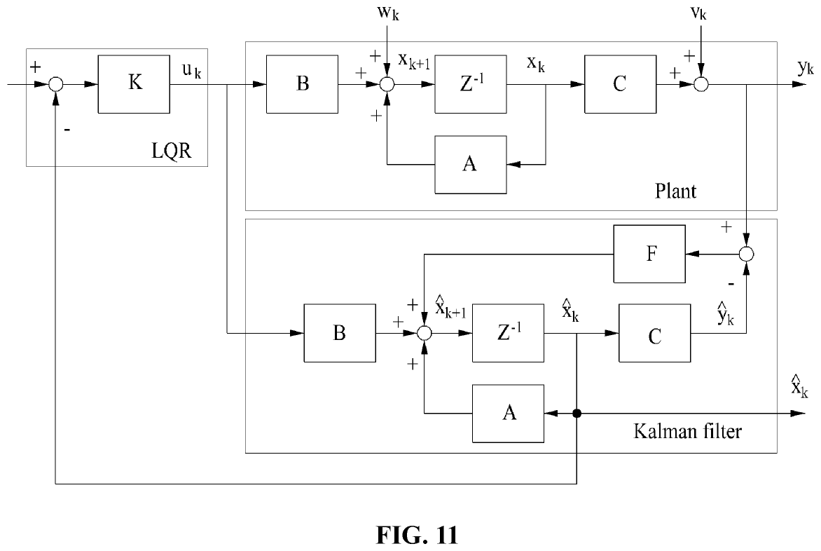

The above-described Equations 3 and 4 may be summarized as Equation 5 below, and Equation 5 below may be visualized as an algorithm that may perform observation through LQR optimal control and eigenvalue allocation as in FIG. 11.

$$\overline{{\hat{x}}_{k + 1}} = [ \begin{matrix}{A}_{k} & {x}_{k + 1} \\ {FC}_{k} & {A}_{k} - {FC}_{k} - {B}_{k} K\end{matrix} ] \overline{{x}_{k}} \qquad [ Equation 5 ]$$

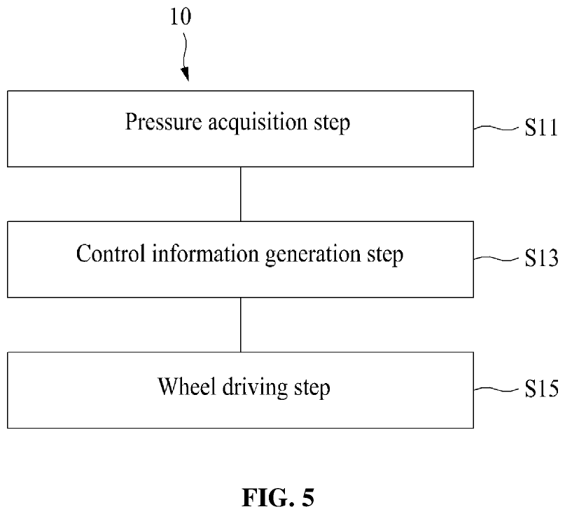

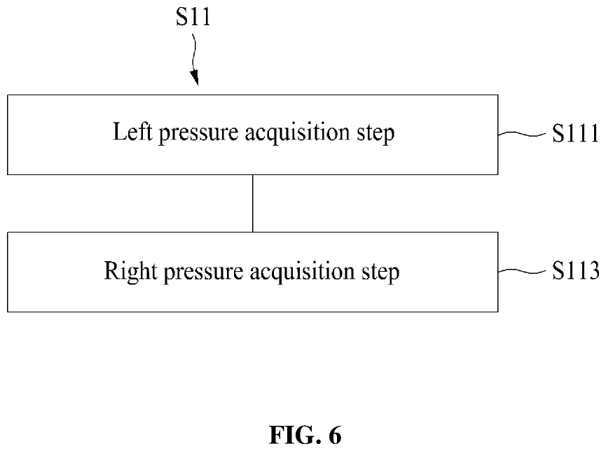

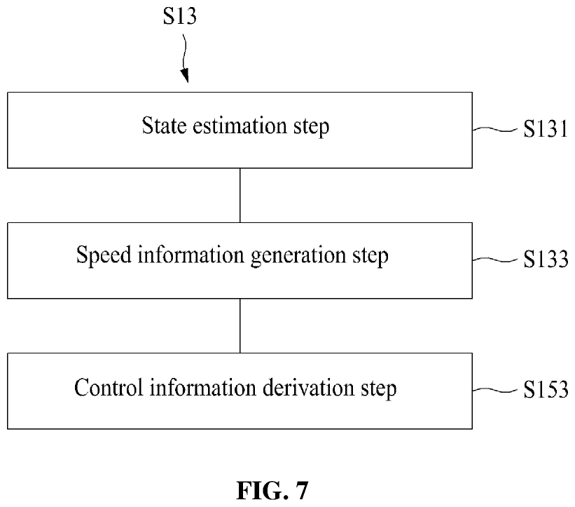

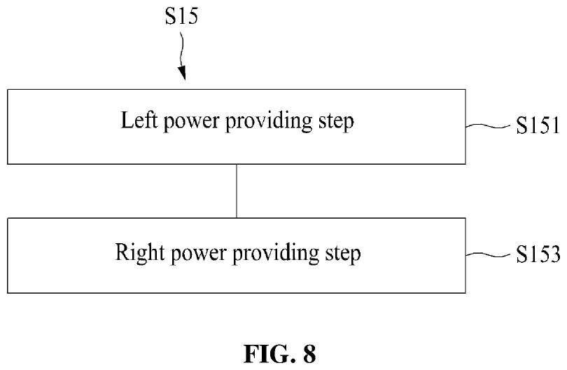

Meanwhile, FIGS. 5 to 8 illustrate an embodiment of a method for controlling a guardian operating handle for a wheelchair according to the disclosure. FIG. 5 is a flowchart of a method for controlling a guardian operating handle for a wheelchair according to an embodiment of the disclosure, FIG. 6 is a flowchart of step S11 of FIG. 5, FIG. 7 is a flowchart of step S13 of FIG. 5, and FIG. 8 is a flowchart of step S15 of FIG. 5.

Hereinafter, the method for controlling a wheelchair guardian operating handle according to the disclosure will be described in detail using FIGS. 5 to 8. Also, for convenience of explanation, FIG. 1 will be used for the description below, but the disclosure is not limited thereto, and devices, systems, terminals, etc. capable of performing various similar functions or operations may be used.

The method 10 for controlling a guardian operating handle for a wheelchair according to an embodiment of the disclosure is configured to operate a wheelchair capable of moving by receiving power using an electric drive system. The wheelchair that may move by receiving power using the electric drive system described below may be a wheelchair equipped with a wheel driving device on a manual wheelchair or an electric wheelchair. For convenience of explanation, the following description assumes that a subject matter wheelchair is an electric wheelchair.

The method 10 for controlling a guardian operating handle for a wheelchair according to an embodiment of the disclosure is configured to perform control of the wheelchair using a pressure applied by the guardian when the guardian applies the pressure to the rear of the electric wheelchair. To this end, the method 10 for controlling a guardian operating handle for a wheelchair according to an embodiment of the disclosure is configured to include a pressure acquisition step S11, a control information generation step S13, and a wheel driving step S15 as shown in FIG. 5.

The pressure acquisition step S11 is configured to obtain a control pressure, which is a pressure applied by the guardian, by using a pressure acquisition unit mounted on the rear of the wheelchair. The pressure acquisition unit may be mounted to the rear of the electric wheelchair in the form of a strain gauge 2 as shown in FIG. 9, and configured to obtain a pressure applied when the guardian applies the pressure thereto. To this end, the pressure acquisition step S11 according to an embodiment of the disclosure is configured to include a left pressure acquisition step S111 and a right pressure acquisition step S113 as shown in FIG. 6.

The left pressure acquisition step S111 is configured to acquire a left control pressure applied by the guardian using a left pressure acquisition module mounted on the left rear side based on the direction of movement of the wheelchair. The left pressure acquisition step S111 may be configured to acquire a pressure applied to the left strain gauge 2a configured on the left side of FIG. 9.

The right pressure acquisition step S113 is configured to acquire a right control pressure applied by the guardian using a right pressure acquisition module mounted on the right rear side based on the direction of movement of the wheelchair. The right pressure acquisition step S113 may be configured to acquire a pressure applied to the right strain gauge 2b configured on the right side of FIG. 9.

At this time, the left pressure acquisition step S111 and the right pressure acquisition step S113 according to an embodiment of the disclosure may be configured to acquire not only a pressure that the guardian pushes, but also a pressure that the guardian pulls toward the rear of the wheelchair. In the case of the pulling pressure, this may be acquired to slow down the moving speed of the wheelchair.

When the pressure is acquired, the control information generation step S13 according to an embodiment of the disclosure is configured to process the control pressure in the control information generation unit to determine the moving speed and generate control information for controlling the wheels equipped on the wheelchair according to the moving speed. To this end, the control information generation step S13 according to an embodiment of the disclosure may be configured to include a state estimation step S131, a speed information generation step S133, and a control information derivation step S135 as shown in FIG. 7.

The state estimation step S131 is configured to acquire the control pressure and estimate an optimal control and Kalman filter state to generate state estimation information. The state estimation step S131 may acquire current movement information to estimate a current movement state of the wheelchair, and further, may estimate a state for the pressure acquired through the pressure acquisition step S11 to generate state estimation information. Here, the state estimation information is information for reducing sensor noise, disturbance, and malfunction, and for this purpose, the state estimation step S131 according to an embodiment of the disclosure may be configured to generate state estimation information using optimal control and Kalman filter algorithms.

The speed information generation step S133 is configured to generate speed information corresponding to the control pressure according to a preset criterion. The speed information generation step S133 may be configured to match the control pressure applied by the guardian to the preset criterion and generate speed information corresponding to the matched criterion. For example, the preset criterion may be set through the current speed of the wheelchair. A wheelchair is generally a device that is not boarded to perform a speed competition, but to provide mobility rights to people with limited mobility. Therefore, the speed of such a wheelchair should preferably be set to a speed similar to a walking or alarm speed.

The speed information generation step S133 is configured to check how close the current speed is to the reference speed and increase the control pressure required to increase the speed in response to the basic purpose of the wheelchair. Therefore, the speed information generation step S133 may be configured to set a pressure range for increasing the speed according to the preset criterion and generate speed information corresponding to the control pressure according to the preset criterion using the current speed and the input control pressure.

The control information derivation step S135 is configured to derive control information by reflecting the state estimation information to the speed information. The state estimation step S131 generates state estimation information including information on the current operation state of the wheelchair and control pressure, and the speed information generation step S133 generates speed information corresponding to the control pressure. Therefore, the control information derivation step S135 of the disclosure may be configured to derive control information including the degree of driving force applied to the wheels equipped on the wheelchair using the state estimation information and the speed information. More specifically, the control information derivation step S135 of the disclosure may be configured to separately derive left control information and right control information and include them all in the control information in order to control power to each of the left and right wheels described below.

The wheel driving step S15 is configured to obtain control information and control the speed of the wheels equipped on opposite sides of the wheelchair according to the control information to perform movement of the wheelchair. To this end, the wheel driving step S15 according to an embodiment of the disclosure may be configured to include a left power providing step S151 and a right power providing step S153 as shown in FIG. 8.

The left power providing step S151 may be configured to provide left power, which is power for a left wheel installed on the wheelchair, in the amount included in the left control information if the control information includes left control information.

The right power providing step S153 may be configured to provide right power, which is power for a right wheel installed on the wheelchair, in the amount included in the left control information if the control information includes the right control information.

The method 10 for controlling a guardian operating handle for a wheelchair according to an embodiment of the disclosure described above may utilize an LQR optimal speed loop control circuit as shown in FIG. 10.

In an embodiment of the disclosure, a formula such as Equation 1 may be used to control a two-axis control state space.

Thereafter, in the state estimation step S131 of the disclosure may select an LQR optimal value by applying eigenvalue allocation and Kalman filters, and this process may be expressed by Equation 2 above.

The state estimation step S131 may declare a new state as expressed in Equation 3 above.

If the state estimation step S131 declares an additional new state after declaring Equation 3 above, this may be expressed as Equation 4 above.

Here, xₖ means the current state, and ek means the error between the estimated value and the current value.

The above-described Equations 3 and 4 may be summarized as Equation 5 above, and Equation 5 above may be visualized as an algorithm that may perform observation through LQR optimal control and eigenvalue allocation as in FIG. 11.

The method for controlling a guardian operating handle for a wheelchair according to the embodiments of the disclosure described above may be implemented as an application (computer program) stored in a storage medium of a computer.

Here, the computer may include a wheelchair guardian operating handle control system.

The operating system of the computer may be an operating system such as Windows or Macintosh installed in a general PC such as a desktop or laptop, or a mobile-only operating system such as iOS or Android installed in a mobile terminal such as a smartphone or tablet PC.

The method for controlling a guardian operating handle for a wheelchair according to the embodiments of the disclosure described above may be implemented as an application (i.e., a computer program) that is installed by default in a computer or installed by a user, and may be stored (recorded) in a computer-readable storage medium.

Likewise, in order for the computer to read the program recorded on the storage medium and execute method for controlling a guardian operating handle for a wheelchair according to the embodiments implemented as a program, the application (application program) described above may include codes coded in a computer language such as C, C++, JAVA, or machine language readable by a processor (CPU) of the computer.

Such codes may include functional codes (Function Code) related to functions that define the functions described above, and may also include control codes related to execution procedures necessary for the processor of the computer to execute the functions described above according to a predetermined procedure.

In addition, such codes may further include additional information necessary for the processor of the computer to execute the functions described above, or memory reference codes related to which location (address) of an internal or external memory of the computer should be referenced.

In addition, if the processor of the computer needs to communicate with any other computer or server located remotely in order to execute the functions described above, the codes may further include communication-related codes regarding how the processor of the computer should communicate with any other computer or server located remotely using the computer's communication module (e.g., wired and/or wireless communication module), what information or media should be sent and received during communication, etc.

In addition, a functional program for implementing the present embodiments and codes and code segments related thereto may be easily inferred or modified by programmers in the technical field to which the disclosure belongs, considering the system environment of a computer that reads a storage medium and executes a program.

In addition, a computer-readable storage medium that records a program as described above may be distributed to computer systems connected to a network, so that computer-readable codes may be stored and executed in a distributed manner. In this case, one or more of multiple distributed computers may execute some of the functions presented above and transmit the execution result to one or more of the other distributed computers, and the computer that received the result may also execute some of the functions presented above and provide the result to the other distributed computers.

A computer-readable storage medium that records an application for executing the method for controlling a guardian operating handle for a wheelchair according to the embodiments of the disclosure, as described above, may include, for example, a ROM, a RAM, a CD-ROM, a magnetic tape, a floppy disk, an optical media storage device, etc.

In addition, a computer-readable storage medium that records an application, which is a program for executing a method for controlling a guardian operating handle for a wheelchair according to embodiments of the disclosure, may be a storage medium (e.g., a hard disk, etc.) included in an application provider server including an application store server, a web server related to an application or a corresponding service, or may be another computer or its storage medium that records the program.

A computer capable of reading a storage medium that records an application, which is a program for executing a method for controlling a guardian operating handle for a wheelchair according to embodiments of the disclosure, may include not only general PCs such as general desktops or laptops, but also mobile terminals such as smart phones, tablet PCs, Personal Digital Assistants (PDAs), and mobile communication terminals, and should be interpreted as all computing-capable devices.

The above description is merely an example of the technical idea of the disclosure, and those with ordinary knowledge in the technical field to which the disclosure belongs will be able to make various modifications and variations without departing from the essential characteristics of the disclosure. Therefore, embodiments disclosed in the disclosure are not intended to limit the technical idea of the disclosure but to explain it, and the scope of the technical idea of the disclosure is not limited by these embodiments. The protection scope of the disclosure should be interpreted by the claims below, and all technical ideas within the equivalent scope should be interpreted as being included in the scope of the rights of the disclosure.

### EXPLANATION OF REFERENCE NUMERALS

1: wheelchair guardian operating handle control system
2: strain gauge
2a: left strain gauge
2b: right strain gauge
11: pressure acquisition unit
13: control information generation unit
15: wheel driving unit
111: left pressure acquisition module
113: right pressure acquisition module
131: state estimation module
133: speed information generation module
135: control information derivation module
151: left power providing module
153: right power providing module

1. A wheelchair guardian operating handle control system configured to operate a wheelchair capable of moving by receiving power using an electric drive system, the wheelchair guardian operating handle control system comprising:
a pressure acquisition unit disposed on a rear side of the wheelchair and configured to acquire a control pressure applied by a guardian;
a control information generation unit configured to process the control pressure to determine a movement speed and generate a control information to control wheels of the wheelchair according to the movement speed; and
a wheel driving unit that configured to acquire the control information and control a speed of each of the wheels positioned on opposite sides of the wheelchair according to the control information to perform the movement of the wheelchair.

2. The wheelchair guardian operating handle control system of claim 1, wherein the pressure acquisition unit comprises:
a left pressure acquisition module, which is disposed on a left rear side based on a direction of the movement of the wheelchair and configured to obtain a left control pressure applied by the guardian; and
a right pressure acquisition module, which is disposed on a right rear side based on the direction of the movement of the wheelchair and configured to obtain a right control pressure applied by the guardian.

3. The wheelchair guardian operating handle control system of claim 2, wherein the control information generation unit comprises:
a state estimation module that configured to obtain the control pressure, estimate an optimal control and Kalman filter state, and generate state estimation information;
a speed information generation module configured to generate speed information corresponding to the control pressure according to a predetermined criterion; and
a control information derivation module configured to reflect the state estimation information in the speed information and derive the control information.

4. The wheelchair guardian operating handle control system of claim 3, wherein the wheel driving unit comprises:
a left power providing module to provide a left power, which is power for a left wheel installed on the wheelchair, in an amount included in left control information if the control information includes the left control information; and
a right power providing module to provide a right power, which is power for a right wheel installed on the wheelchair, in the amount included in the left control information if the control information includes right control information.

5. A method for controlling a guardian operating handle configured to operate a wheelchair capable of moving by receiving power using an electric drive scheme, the method comprising:
acquiring a control pressure applied by a guardian by using a pressure acquisition unit disposed on a rear side of the wheelchair;
processing the control pressure to determine a movement speed, and generating control information to control wheels of the wheelchair according to the movement speed by using a control information generation unit; and
acquiring the control information and controlling a speed of each of the wheels positioned on opposite sides of the wheelchair according to the control information by using a wheel driving unit to perform the movement of the wheelchair.

6. The method of claim 5, wherein the acquiring the control pressure comprises:
positioning on a left rear side based on a direction of the movement of the wheelchair and acquiring a left control pressure applied by the guardian; and
positioning on a right rear side based on the direction of the movement of the wheelchair and acquiring a right control pressure applied by the guardian.

7. The method of claim 6, wherein the processing the control pressure comprises:
obtaining the control pressure and estimating an optimal control and Kalman filter state to generate state estimation information;
generating speed information corresponding to the control pressure according to a predetermined criterion; and
deriving the control information by reflecting the state estimation information into the speed information.

8. The method of claim 7, wherein the acquiring the control information comprises:
providing left power, which is power for a left wheel installed on the wheelchair, in an amount included in left control information if the control information includes the left control information; and
providing right power, which is power for a right wheel installed on the wheelchair, in the amount included in the left control information if the control information includes right control information.
